(19) United States
(12) Patent Application Publication
(10) Pub. No.: US 2006/0232083 A1
(43) Pub. Date: Oct. 19, 2006

(54) Sanitation device for collecting and disposing of animal droppings

(76) Inventor: Pavel Kamenkovich, New York, NY (US)

Correspondence Address: Pavel Kamenkovich, 8615 Fort Hamilton PKWY # A34, Brooklyn, NY, 11290, US

(21) Appl. No.: 11/111,669

(22) Filed: Apr. 19, 2005

(51) Int. Cl. A01K 29/00

(52) U.S. Cl. 294/1.5

(57) ABSTRACT

The sanitation device is for collection and disposal of animal droppings, particularly dogs' droppings. The sanitation device includes the open-ended lower and upper annular members that are clamped an edge of an open portion of the disposable plastic bag. An opposite halves of lower and upper annular members are provided connecting and locking means. The device includes handle means having a long handle connecting by means of a rake with locking means. A lower part of the lower annular member is provided insulating odor means comprising an elastic ring is mounted on screws and a string, small rings are installed on each side of octagon and the string is passed of all small rings. Ends of the string are loosely tied and connected with the rectangular reel. The present device may be used to catch or scrape up dog's droppings. Dog owners do not have to touch the disposable plastic bag with dropping. It is odor and hassle free. The sanitation device can easily be used multiple times and for multiple dogs; it can be used for dogs of all sizes. The sanitation device has a simple design and a low manufacturing cost.

### BACKGROUND

### Description of Prior Art

The lightweight sanitation device may be carried in the same manner as a stick or cane for example when walking a dog.

It has been recognized for some time that dog feces represent a serious environmental problem, particularly in large cities. It has been estimated that in New York City about 200,000 pounds of dogs' stool are deposited every day on sidewalks, streets, parks and playgrounds. Many different types of illnesses have been spread through the droppings of household pets.

Most clean up devices are cumbersome and do not lend themselves to being carried along on dog walk. A dog walker should be able to quickly and easily collect dog's droppings and carry it some distance along the way of his public “dog walk” until a suitable disposal area can be reached.

The means of collecting and disposing should be sanitary, and it should provide odorless and convenient transportation of the dog's droppings until it can be disposed off.

A plastic bag is the most popular device for picking up solid dog waste from the street, sidewalk or parks. However, at times dog owners forego picking up the waste, one reason being it is distasteful to them to handle it. Also, a very soft dog waste cannot be picked up entirely.

U.S. Pat. No. 4,205,869 to Mathis [issued Jun. 3, 1980]

The device comprises a collapsible disposable cardboard container, a supply of disposable plastic bags which can fit as a liner within the cardboard container, and small disposable scoop or paddle associated with each plastic bag. In use, a person walking a dog would carry the box in collapsed condition in a pants pocket or purse, along with one or more bags and scoops. The device cannot be used to catch animal droppings before it falls on the ground. Also the device requires both hands to operate it.

U.S. Pat. No. 3,872,831 to Cassidy [issued Mart 25, 1975]

The device allowing a person standing upright to hold the disposable bag near the ground so that bag is positioned to receive dog's stool directly. But the device cannot be used to scrape up dog's feces into the disposable bag. The device is cumbersome because the long handle cannot detach from the annular member.

U.S. Pat. No. 4,042,269 to Skermetta [issued Aug. 16, 1977]

The device has the container may be used to catch animal droppings or to scrape up animal droppings such as fecal matter of a dog. But the device is cumbersome because the long handle cannot detach from the container and has a complicated design. It is very difficult to pick up animal droppings from the ground scraping the forward edge of the container along the ground.

US Pat. Application No. 20030005891 to Lin Lu [issued Jan. 9, 2003]

The device has a simple design and a low selling price. But the device is difficult to use because a dog moves around before it is ready to eliminate; dog walker has to follow the dog with the device from place to place also. It is not convenient for dog walker. Also, the device requires both hands to operate it.

### OBJECTS AND ADVANTAGES

The object of the present invention is to provide a sanitation device which can easily catch or scrape up animal droppings into a disposable plastic bag. The sanitation device can be easily disconnected for transportation and stored in a purse.

The sanitation device is inexpensive to manufacture because it has a simple design.

The sanitation device allows minimizing odors from animal droppings.

The sanitation device allows to avoid touching a disposable plastic bag with animal droppings.

The sanitation device can be easily used multiple times for multiple dogs, regardless of the dog's size.

In Accordance one aspect of this invention the sanitation device comprises holder means for a disposable plastic bag.

Holder means include an open-ended lower annular member and an open-ended upper annular member between which the plastic bag is clamped.

Opposite halves of open-ended lower and open-ended upper annular members are provided connecting means and locking means.

Connecting means comprising a guide pan is attached to an upper portion of the open-ended upper annular member. An unused end of the guide pan is connected by means of an U-shape elastic element to the open-ended lower annular member. The elastic element is always under tension.

Locking means comprising a shelf is connected with the open-ended lower annular member and has a hole in which is inserted a rampart.

Insulating odor means comprising an elastic ring and a string which are installed by means of a screws or hooks on a lower portion of the open-ended lower annular member.

The sanitation device can be to keep holder means and insulating odor means in open or closed position by means of rotation the long handle, the rake and the rampart around its vertical axles. The long handle with the rake can be disconnect from the upper portion of the rampart and used for scraping animal droppings using the rake along the ground and the guide pan to the disposable plastic bag.

### SUMMARY

In accordance with the present invention a holder means comprises open-ended lower and upper annular members between which a plastic bag is clamped. Opposite halves open-ended lower and upper annular members are provided connecting and locking means. Locking means are connecting with handle means.

Insulating odor means are connected to a lower part of the open-ended lower annular member.

### DRAWINGS

### DRAWING FIGURES

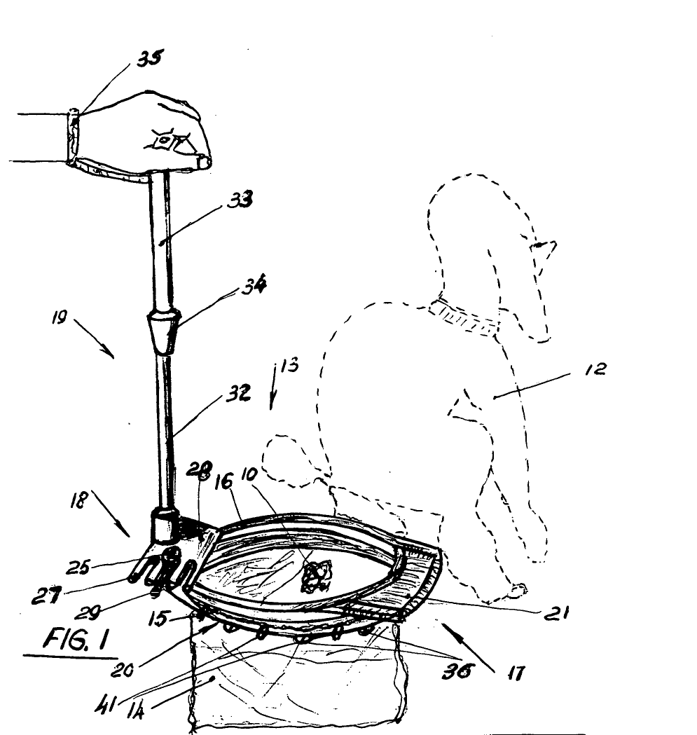

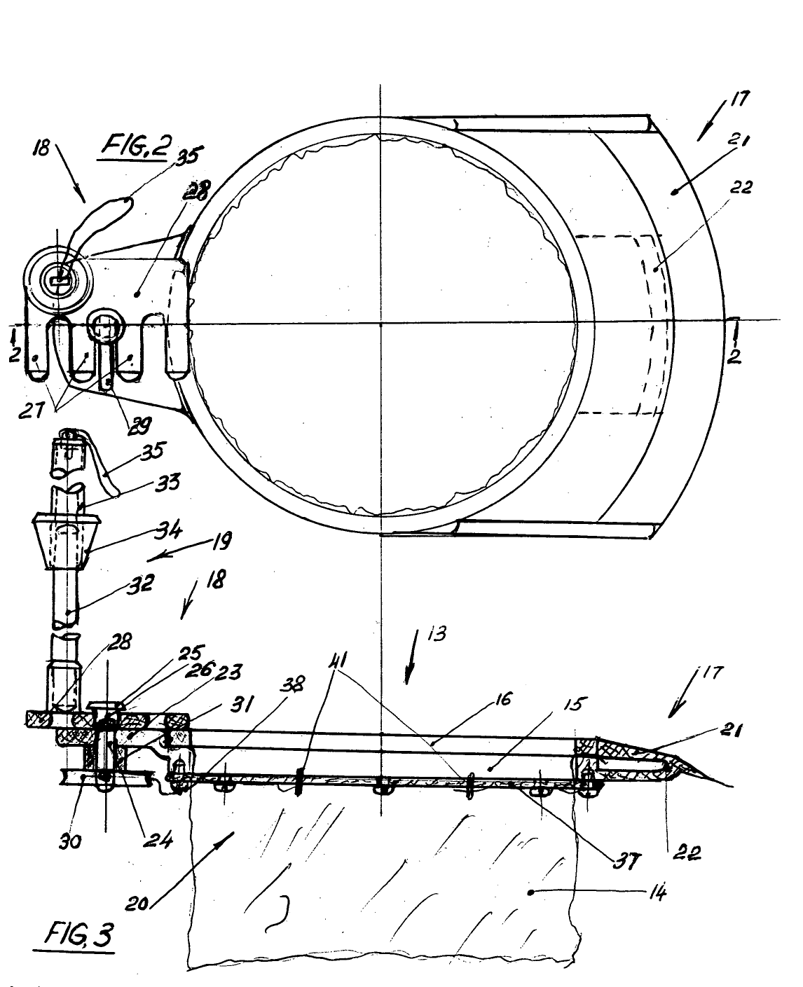

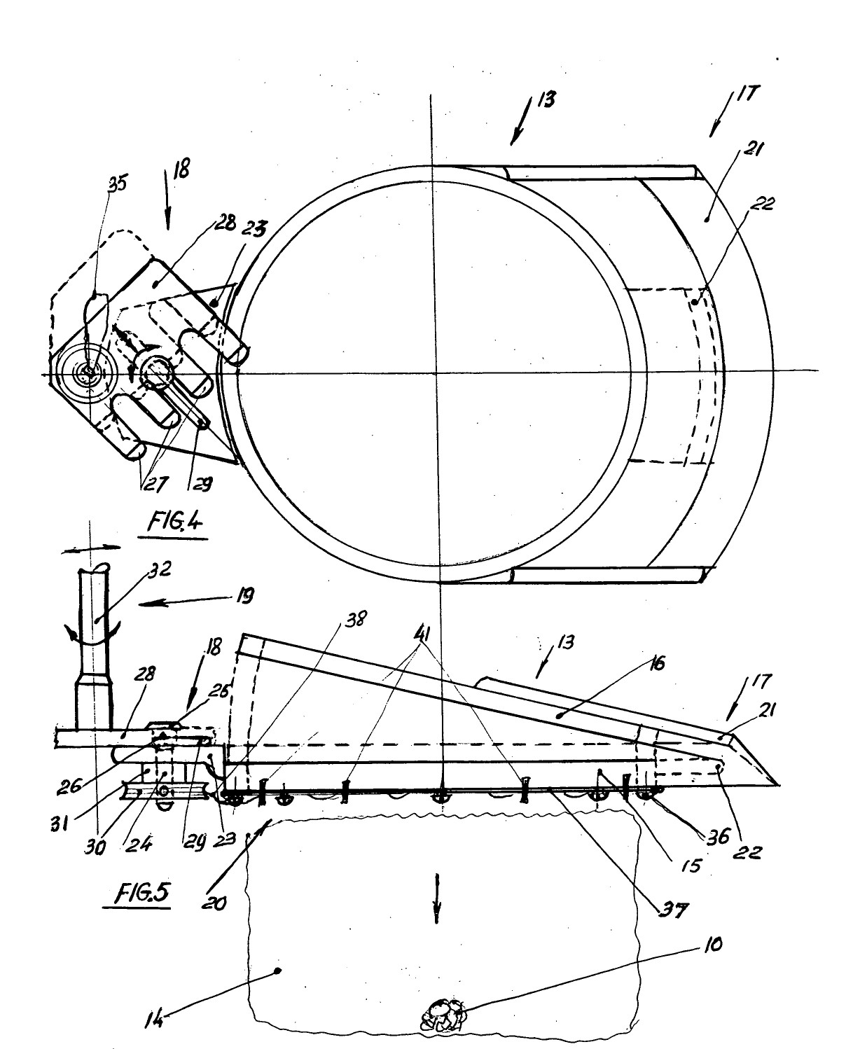

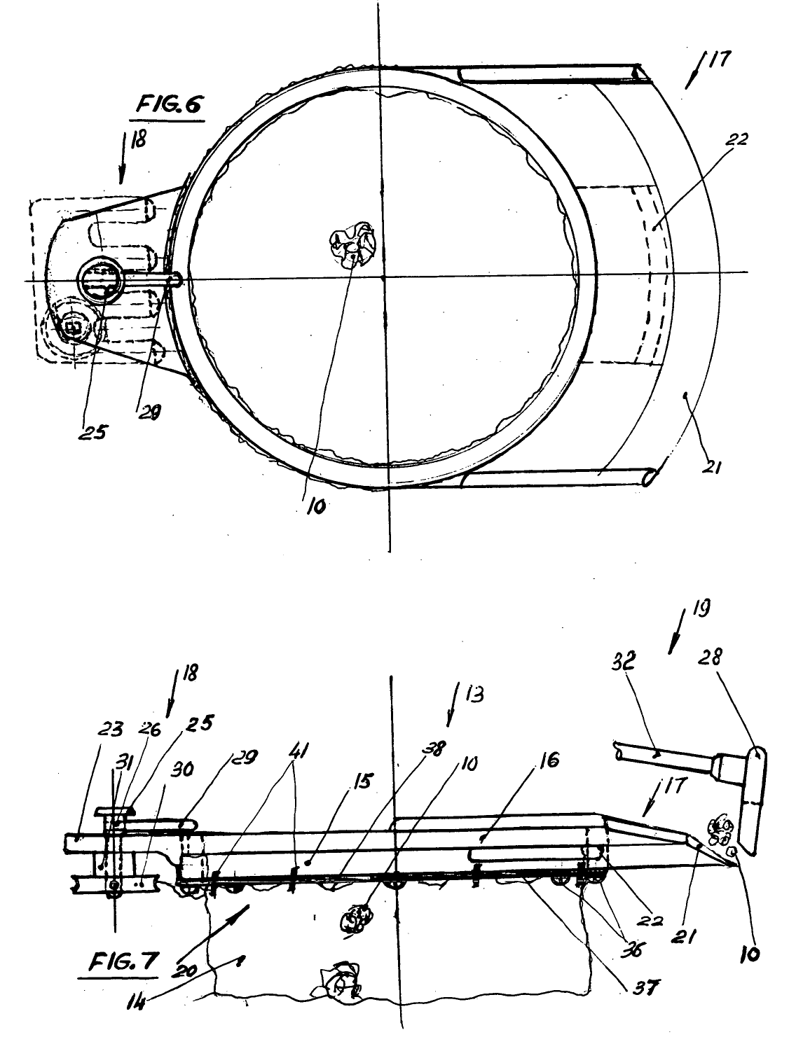

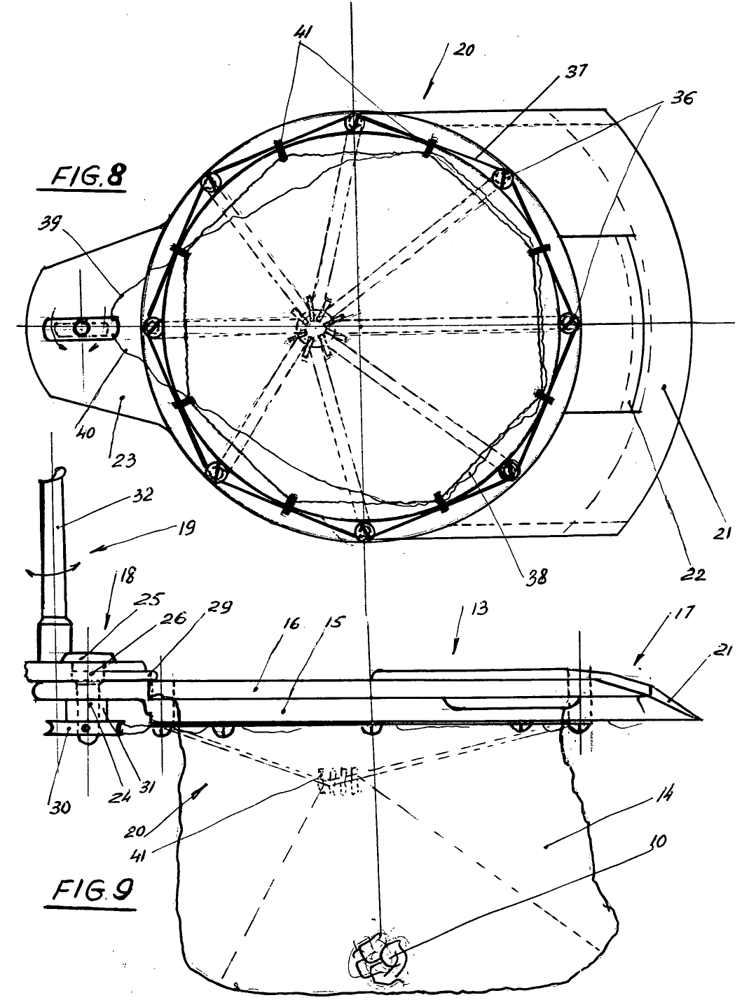

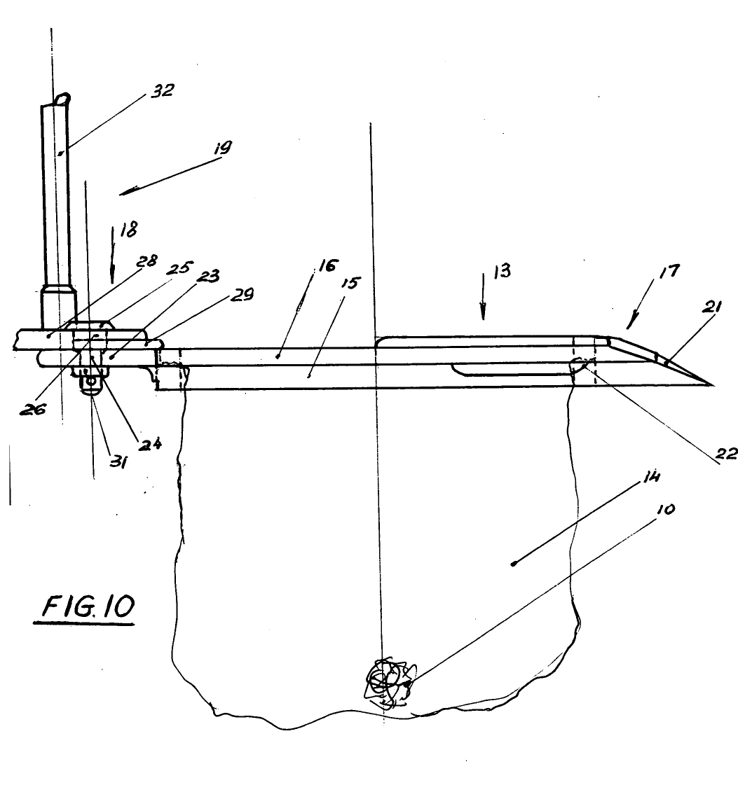

FIG. 1 is a perspective view of the sanitary device being used to catch animal droppings.

FIG. 2 is a plan view of the sanitary device.

FIG. 3 is a sectional view taken of along the line 2-2 FIG. 2.

FIG. 4 is a plan view of the sanitary device illustrating a position locking means before removal the animal droppings with a plastic bag.

FIG. 5 is a side view of the sanitary device illustrating removal of the animal droppings with a plastic bag.

FIG. 6 is a plan view of the sanitary device illustrating removal of handle means.

FIG. 7 is a side view of the sanitary device being used to scrape up animal droppings.

FIG. 8 is a bottom view of sanitary device.

FIG. 9 is a side view of the sanitary device illustrating being used insulating odor means.

FIG. 10 is side view of the sanitary device illustrating without used insulating odor means.

### REFERENCE NUMERALS IN DRAWINGS

10 Animal droppings.
12 Dog.
13 Holder means.
14 Plastic bag.
15 Lower open-ended annular member.
16 Upper open-ended annular member.
17 Connecting means.
18 Locking means.
19 Handle means.
20 Insulating odor means.
21 Guide pan.
22 U-shape elastic element.
23 Shelf.
24 Rampart.
25 Head.
26 Upper portion of the rampart.
27 Teeth.
28 Rake.
29 Bar.
30 Rectangular reel.
31 Washer.
32 Lower tube.
33 Upper tube.
34 Nipple.
35 Wrist strap.
36 Screws.
37 Elastic ring.
38 String.
39 End of string.
40 End of string.
41 Small rings

### DETAILED DESCRIPTION

Referring first FIG. 1 there is shown a perspective view of the sanitation device being used animal droppings 10 of the dog 12 shown in dotted lines.

The sanitation device include holder means 13 for a disposable plastic bag 14. The main parts of the holder means 13 is an open-ended lower annular member 15 and an open-ended upper annular member 16 between which an edge of an open portion the disposable plastic bag 14 is clamped.

Connecting means 17 and locking means 18 are installed on opposite halves of the open-ended lower and open-ended upper annular members 15, 16.

Handle means 19 are attached to locking means 18 and manufactured replaceable.

Insulating odor means 20 are connected to a lower part of the open-ended lower annular member.

Referring now to FIG. 2 there is shown a plan view of the sanitation device and FIG. 3 there is shown a cross-sectional view taken of along the line 2-2 FIG. 2.

Connecting means 17 comprising a guide pan 21 is attached to the upper portion of the half of the open-ended upper annular member 16 along its perimeter and an U-shape elastic element 22 is connected with an unused end of the guide pan 21 and an adjacent half of the open-ended lower annular member 15 along of a center of its perimeter. The U-shape elastic element is always under tension.

Locking means 18 consist a shelf 23 is attached to the open-ended lower annular member 15.

Upper surfaces the shelf 23 and the open-ended upper annular member 16 are disposed onto a common horizontal level. A rampart 24 is put in a hole of the shelf 23. The rampart 24 has a head 25. An upper portion 26 of the rampart 24 is inserted between an adjacent teeth 27 of the rake 28. The upper portion 26 has a bar 29 which is located between adjacent teeth 27 and touch the upper surfaces of the shelf 23 and the open-ended upper annular member 16. A rectangular reel 30 is installed on a lower end of the rampart 24. A washer 31 is mounted between the rectangular reel 30 and a lower surface of the shelf 23.

The handle means 19 manufactured extensible include a long handle consisting a lower tube 32 inserting in an upper tube 33 and fixing by means of a nipple 34. The lower tube 32 is connected with the rake 28. The upper tube 33 has a wrist strap 35.

Referring now to FIG. 8 there is shown a bottom view of the sanitation device including insulating odor means 20 which comprising eight screws 36 are attached to a lower part of the open-ended lower annular member 15 along its perimeter with equal intervals. An elastic ring 37 is mounted on the screws 36 and forms an octagon where the screws 36 are tops of the octagon and the elastic rings 37 are its sides. Small rings 41 are installed on each side of the octagon and a string 38 is passed of all small rings 41. Ends 39,40 of the string 38 are loosely tied and connected with rectangular reel 30.

Operation—FIG. 1, 4, 5, 6,7,8,9.

As can be seen in FIG. 1, the sanitation device allow a person standing upright to hold the disposable plastic bag 14 near the ground and it is positioned to receive directly the dog's droppings 10.

As shown in FIG. 6, 7 the sanitation device allows a person to pick up the dog's droppings 10 from the ground also.

A person detaches the rake 28 connecting with handle means 19 from the upper portion 26 of the rampart 24. The bar 29 is set up in closed position as shown in FIG. 6. The holder means 13 with the disposable plastic bag 14 put down the ground and a forward edge of the guide pan 21 is located opposite of the dog's droppings 10. Then a person, as shown in FIG. 7, by means of the rake 28 connecting with handle means 19 scraping dog's droppings 10 along the ground and the guide pan 21 to the disposable plastic bag 14 which must be disposed; person attaches the handle means 19 by means of the rake 28 to the upper portion 26 of the rampart 24. Then a person rotates handle means 19 around of it's a vertical axle, the rampart 24, the rake 28, the bar 29 and the rectangular reel 30 rotate also. Ends 39,40 of the string 38 winds around the rectangular reel 30 and forms a small knot. Sides of the elastic ring 37 and small rings 41 pull together to a center of the disposable plastic bag 14. The elastic ring 37, the string 38 and small rings 41 shown in FIG. 8 and FIG. 9 in broken lines. These positions of the string 38 and the elastic ring 39 allows to minimize odor from dog's droppings 10 in the disposable plastic bag 14. Then a person moves the sanitation device to a trash can [not shown in FIG. 5] and stops the sanitation device above the trash can. A person rotates handle means 19 with the rake 28, the bar 29 in an opposite direction and stops in a position as shown in FIG. 4 and FIG. 5. The upper annular member 16 moves up by means of the elastic element 22. The rectangular reel 30 continues to turn before the string 38 by means of elastic ring 39 stops in open position. At that point dog's droppings 10 with the disposable plastic bag 14 falls into the trash can.

I claim:

1. A sanitation device for collecting and disposing of animal droppings particularly from dogs comprising;
holder means for a disposable plastic bag, said holder means comprising an open-ended lower and an open-ended upper annular members, an edge of an open portion of said disposable plastic bag is clamped between said open-ended lower and upper annular members, locking and connecting means are installed on opposite halves of said open-ended lower and upper annular members, handle means are attached to said locking means, insulating odor means are connected to a lower part of said open-ended lower annular member.

2. The sanitation device as given in claim 1 wherein said locking means comprising a shelf is attached to said open-ended lower annular member upper surface of said shelf and an upper surface of said upper annular member are disposed onto a common horizontal level, said shelf has a hole and a rampart is put in said hole, said rampart has a head and a cylindrical body, an upper portion of said body is provided a bar is touching on upper surfaces of said shelf and open-ended annular member, is disposed between an adjacent teeth of a rake is inserted of said head and the upper surface of said shelf, a rectangular reel is installed on a lower end of said body of said rampart under of said shelf.

3. The sanitation device as given in claim 1 wherein said connecting means comprising; a guide pan is attached to an upper portion of a half said open-ended upper annular member is disposed opposite said shelf, an U-shape elastic element is connected with an adjacent half of said open-ended lower annular member and an unused end of said guide pan.

4. The sanitation device as given in claim 1 wherein said handle means comprising a long handle is attached to said rake.

5. The sanitation device as given in claim 4 wherein said long handle is manufactured replaceable and extensible.

6. The sanitation device as given in claim 1 wherein said insulating odor means comprising several screws or hooks, preferably eight, are attached to a lower part of said open-ended lower annular member evenly along its perimeter an elastic ring is mounted on said screws or hooks said ring and said screws form an octagon where said screws are tops of said octagon and said ring forms sides of said octagon small rings are installed on said each side of said octagon and a string is passed of all said small rings ends of said string are loosely tied and connected with said rectangular reel.

7. The sanitation device according to claim 1, alternative comprising of said insulating odor means could be removed to reduce the production cost and selling price.
